(19) United States
(12) Patent Application Publication
(10) Pub. No.: US 2023/0416116 A1
(43) Pub. Date: Dec. 28, 2023

(54) SYSTEM FOR CONDITIONING WATER QUALITY

(71) Applicant: Caron Products and Services, Inc., Marietta, OH (US)

(72) Inventors: Milton F. Baker, Vincent, OH (US); Robert W. Dotterer, Sardis, OH (US); Brian K. Haught, Marietta, OH (US); Zachery T. Mallett, Marietta, OH (US)

(21) Appl. No.: 18/213,240

(22) Filed: Jun. 22, 2023

Related U.S. Application Data
(60) Provisional application No. 63/354,467, filed on Jun. 22, 2022.

(51) Int. Cl. C02F 1/00; C02F 9/00; F24F 3/14

(52) U.S. Cl. CPC C02F 1/008; C02F 9/00; F24F 3/14; C02F 1/32; C02F 2209/42; C02F 2303/04; C02F 2201/005

(57) ABSTRACT

A system for providing conditioned water. A holding reservoir receives intake water, of unknown quality, from a water source and a pump pressurizes the system. Water flow paths through the system are controller by opening and closing a plurality of controllable valves. A sensor measures the water quality of the water in the holding reservoir and produces a signal representative of the measured water quality. A microprocessor receives the signal, compares the measured water quality with a desired water quality range, and produces conditioned water by controlling valves to deionize the water or to ionize the water, as needed. An output valve controls outflow of the conditioned water to a humidification or environmental chamber for humidifying the chamber.

### CROSS REFERENCE TO RELATED APPLICATIONS

This application claims benefit of Provisional Application No. 63/354,467, filed Jun. 22, 2022, the entire contents of which are incorporated by reference as if fully set forth herein, under 35 U.S.C. § 119(e).

### BACKGROUND OF THE INVENTION

A control mechanism within an environmental chamber controls the air temperature and humidity within the chamber. A user sets the desired temperature and (relative) humidity values. Responsive thereto, the control mechanism heats or cools and humidifies or dehumidifies the air within the chamber according to a predetermined software program to reach and then maintain the temperature and humidity settings.

Water is used to increase the humidity within the chamber. The quality of water used to increase the humidity is important. Water with impurities, such as dissolved solids, leaves a residue after the water has evaporated. This causes scale build-up on the humidification device, including its heater or atomizer, as well as nearby surfaces, and thereby increases the maintenance tasks to maintain the chamber in good operating condition.

Water that is too pure (i.e., does not contain enough ions) is corrosive and degrades chamber components and the chamber interior wall surfaces. This corrosive behavior increases at higher temperature and humidity levels within the chamber.

Common water quality units of measure include: resistivity, conductivity, total dissolved solids, and hardness.

Experience has shown that water resistivity values between about 50 kΩ-cm and about 1MΩ-cm represents a favorable range for water that will be used to humidify an environmental chamber.

Water within this ideal resistivity range has a higher resistivity than tap water (with a resistivity about 1000 to 5000 ohms-cm). Typical processes used to raise the resistivity of tap water (or its equivalent, lowering water conductivity) include distillation, reverse osmosis, and deionization. All are common practices and the art of practicing such techniques to bring water resistivity to a value within this range is well established.

Ultra-pure water (with a resistivity of about 18.3 MΩ-cm) has many uses in the laboratory and is therefore readily available. However, its purity exceeds the ideal resistivity range for humidification water. Dilution to lower resistivity can be achieved by mixing the ultra-pure water with tap water (or with any water that is “less pure”) in a calculated ratio such that the resistivity of the diluted water is within the desired range. However, this process requires two water sources (i.e., ultra-pure water and tap water) and thus is not an ideal solution.

Bubbling gas (CO2) through the ultra-pure water also produces ions and lowers the water resistivity.

These processes to raise and lower the water resistivity are commonly employed and the art practicing each of these techniques is well established.

### BRIEF DESCRIPTION OF THE FIGURES

The present invention can be more easily understood and the advantages and uses thereof more readily apparent when the detailed description of the present invention is read in conjunction with the figures wherein:

FIG. 1 set forth water quality parameters, including recommended and non-recommended ranges.

FIG. 2 illustrates a block diagram of the present invention

FIG. 3 illustrates a flowchart depicting operation of the present invention.

FIG. 4 illustrates a commercial embodiment of the present invention.

FIG. 5 illustrates a detailed piping diagram of a system constructed according to the teachings of the present invention.

In accordance with common practice, the various described and illustrated features are not drawn to scale, but are drawn to emphasize specific characteristics relevant to the invention. Like reference numerals denote like elements throughout the figures and text.

### DETAILED DESCRIPTION OF THE INVENTION

The end-use of a water purifier system is well defined, i.e., for either ionizing or deionizing water, and removing particulates and bacteria. Advantageously, a system of the present invention senses/measures the water quality and then activates an ionizing or deionizing process to reach a desired resistivity target.

The present invention can also activate other processes (by opening or closing certain valves) appropriate during or following the ionizing or deionizing process, including a bleed bypass recirculation loop to prevent the water from stagnating and recirculation of return water (condensate) from environmental/humidification chambers.

Antimicrobial coatings (such as silicon dioxide) are applied to the interior surfaces of the various system components, especially including interior surfaces of bacteria-prone reservoirs and pipes and wetted surfaces. Antimicrobial materials (such as silver or copper) that have direct contact with water are used.

As known by those skilled in the art, environmental chambers comprise an enclosure for testing the effects of specified environmental conditions on biological items, industrial products, materials, and electronic devices and components. Typically, both temperature and humidity are controllable within an environmental chamber.

A humidity chamber, a subcategory of environmental chambers, provides a controllable humidity within the chamber enclosure. Thus, the humidity chamber requires a water source supplying water with a resistivity value within a specified range.

The present invention provides multiple processes for achieving a desired water quality within a single novel and nonobvious system. Advantageously, the system of the invention can be used with any enclosure that requires a water supply to increase or decrease the humidity level within the enclosed space of the chamber. Herein those chambers are referred to as humidification chambers.

In one operating mode, the system of the invention receives water of an unknown water quality, for example, ranging from ordinary tap water to ultra-pure water, and treats the water to achieve desired water quality parameters. The quality of the incoming water is not necessarily always constant.

As used herein, water quality generally refers to water resistivity, although other water characteristics may be considered measures of water quality, such as hardness and total dissolved solids.

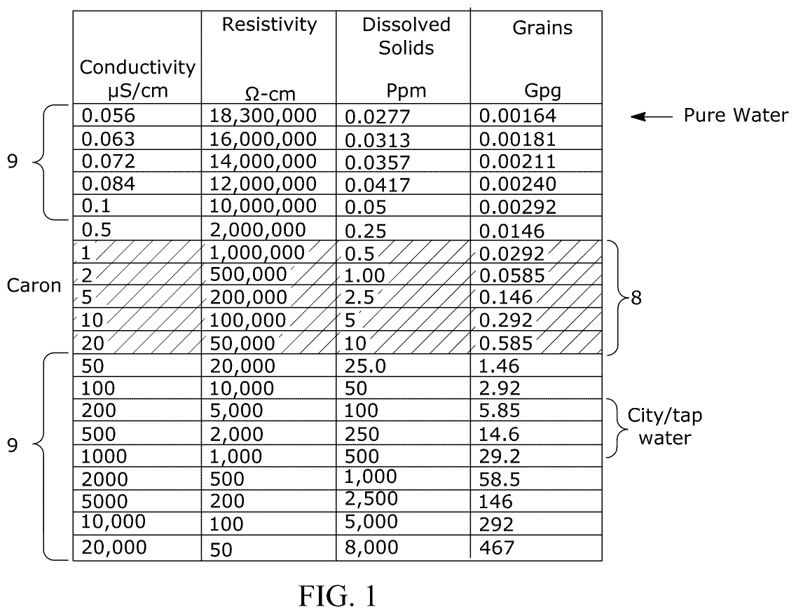

FIG. 1 sets forth multiple water quality parameters and recommended ranges 8 and non-recommended ranges 9 (recommended by the Assignee of the present invention) for water used for humidification purposes in a humification chamber. Ideally, the water quality parameters should stay within the band designated by reference character 8. The recommended resistivity range is between 0.05 Mohm-cm and 1 Mohm-cm. The table values are shown for water at 25° C.

The incoming water line may be hard-plumbed and thus the water flow is automatically activated as needed. Alternatively, the water may be manually supplied (e.g., poured) into the system. Especially in the latter case, the water source may vary from among city water drawn from a spigot, distilled water purchased at a store, and ultra-pure water on tap.

Advantageously, the system of the present invention can accommodate input water as supplied from any source (including single and multiple sources) and with any resistivity. Water from multiple sources means the water will exhibit multiple resistivity values. The system must also consider multiple variables, such as: what is the ambient air in the water storage container, what product containers are in the chamber, did the water pass through soil for growing plants? The input water quality (especially for condensate returning from the chamber) is thus not controlled nor controllable and the present invention must therefore be able to accommodate input water from any source and in any condition.

Certain prior art water conditioning systems assume, disadvantageously, that the input water is always of a certain or fixed quality or always from a defined source, e.g., always tap water or always distilled water. Such a prior art system can therefore assume that the quality parameters of the input water are always within a certain range. In such situations, the operations required to purify the input water are known in advance, e.g., purify or dilute the water and the extent to which those purify or dilute operations must be performed.

In contrast, the present invention accepts water of any quality, e.g., resistivity too high or resistivity too low, or another water quality metric outside a desired range. In one embodiment of the present invention (commercially referred to as model CRSY102), a numerical value of the output water resistivity metric is a predetermined value within a range of values. And the resistivity of the incoming water can be increased or decreased by subjecting it to different processes.

According to another embodiment (commercially referred to as model CRSY103), a user or operator inputs into the water quality conditioning system a numerical value or range of values for a desired water quality parameter, such as resistivity. The system then conditions the input water to produce output water that is within the specified range. This latter second embodiment is the subject of a separate co-owned patent application.

The system of the present invention can operate as a standalone unit or can be physically attached to and operate in conjunction with an environmental chamber.

In one embodiment, the system can produce output water with resistivity within a range from about 50 kΩ-cm to about 1 MΩ-cm. See the recommended band 8 in FIG. 1. This range is acceptable for use in most environmental chambers. In practice, the resistivity value of the output water is controlled to be within a significantly narrower range.

In operation: (1) a sensor measures the quality of the source water (specifically in one case, measures the resistivity); (2) a microprocessor compares the measured value against the desired value or desired range of values; (3) the microprocessor activates a corresponding process (primarily by opening and closing certain valves to control the water flow path to bring the water quality parameter (typically resistivity) to within the desired range by: (4a) activating an ion exchange resin to deionize the water and then pumping the water through the resin, or (4b) pumping ambient air (containing CO2) though the source water to ionize the water.

Typically, water from all sources or inputs is initially stored in a tank and thus according to step 4b the air is pumped through the water in the tank to ionize the tank water. Alternatively, the air can be pumped into water flowing out from the tank.

In another application, the system receives and mixes re-claimed (condensate) water from a single source or from multiple sources (that is, from a single environmental chamber or from multiple environmental chambers) and performs the same operations as set forth above.

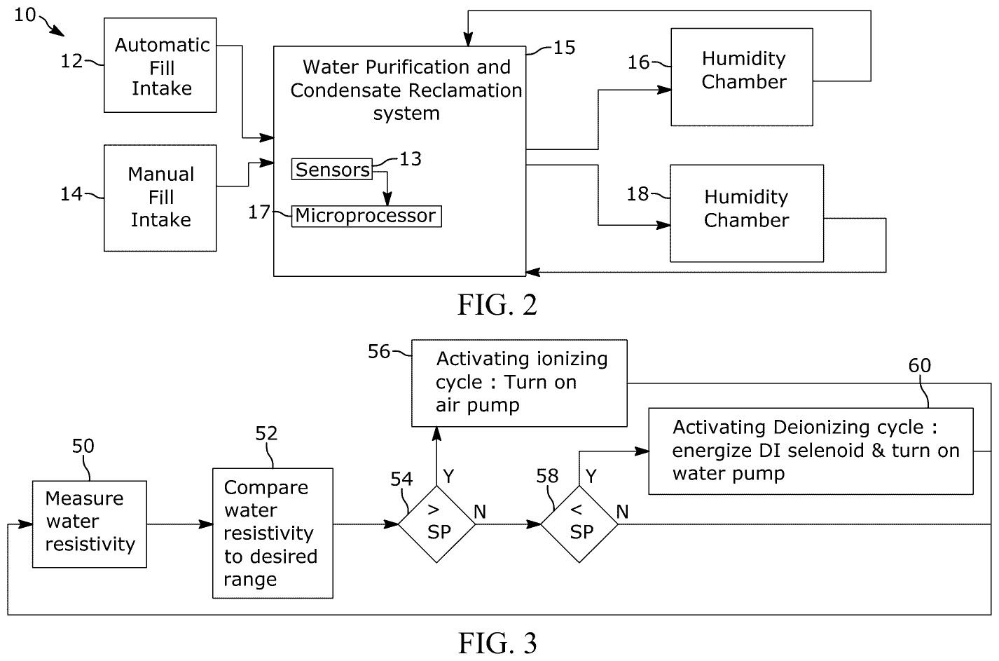

FIG. 2 is a block diagram of input water sources and output water destinations for a system 10 of the invention.
At different times and in different applications, the automatic fill intake 12 may supply ‘dirty’ city-treated tap water into the user's facility.
Alternatively, the automatic fill intake 12 may supply ultrapure water that may need to be ionized.
And alternatively, the automatic fill intake 12 may represent single-pass reverse osmosis (RO) water that requires deionization.
In any case, the automatic fill intake 12 is controlled to allow water intake when the water level falls below a predetermined value and terminate the water intake when the water level reaches a predetermined value.
Likewise, the manual fill input intake 14 may supply ‘dirty’ city-treated tap water, ultrapure water from an internal water source, purchased RO water, a user's internal or purchased double-pass RO water, distilled water purchased or distilled on-site, or water for injection (WFI), that is, purchased sterile water.
In either case, whether the water is input automatically or manually, the water may need to be ionized or deionized and the amount of ionization or deionization may change over time dependent on the quality and amount of the water input. The system of the invention can accommodate these varying conditions.
Sensors 13 with a subsystem 15 determine certain water parameters, input the sensor data to a microprocessor 17 (or controller). The microprocessor analyzes the sensor data, compares the data to predetermined desired ranges or values and in response thereto generates control signals to control operation of various system elements, e.g., open solenoid-operated valves to control water flow to various system elements. The system elements ionize or deionize the water, remove particulates, etc. and supply the output water to humidity chamber 16 or 18.
Return water (condensate) condensed from humidity within either or both of the humidity chambers 16 and 18 is returned to the subsystem 15 for analysis by sensors 13 and control of water flow paths by the microprocessor 17. This water is likely contaminated with bacteria, spores, airborne contaminates, etc. Typically, this water resistivity is unknown and the water may need to be ionized or deionized prior to reuse. The subsystem 15 is also usable with other types of environmental chambers, in lieu of or in addition to a humidity chamber, although when used with certain environmental chambers there is no condensate return water.
Regardless of the quality of the water from these four drastically different and varying input water sources, the output water from the subsystem 15 as supplied to the humidity chambers 16 and 18 (or to other environmental chambers) must be consistently within the desired water quality range. Ideally, it must also be free of particulates and microbial contamination.

The system of the invention also offers a number of features and operations that aid in maintaining or improving other water quality metrics for the supplied water.

FIG. 3 is a flowchart illustrating the principle steps and operation of the system 10.

At a step 50, the resistivity of the input water, from any source and supplied automatically or manually, is measured.

Decision steps 54 and 58 classify the measured resistivity value as greater than (decision step 54) a setpoint value of less than a setpoint value (decision step 58).

If the decision step 54 determines that the water resistivity is greater than the setpoint value, processing proceeds to a step 56 where an ionizing cycle is activated, typically by opening/closing predetermined solenoid-operated valves. In one embodiment the ionization process activates an air pump and injects air (i.e., CO2) into the water.

If at the decision step 54 the water resistivity is not greater than the set point value (a negative result), processing proceeds to a decision step 58 to determine if the resistivity is less than the setpoint resistivity value. An affirmative result from the decision step 58 moves processing to a step 60 where a deionizing cycle is activated. In one embodiment, the water is made to flow through a deionizing resin by control of the water flow path.

A negative output from the decision step 58 returns processing to the step 50 for measuring the resistivity of additional water input to the system 10.

Note too, that after the steps 56 and 60, processing also returns to the resistivity measuring step 50.

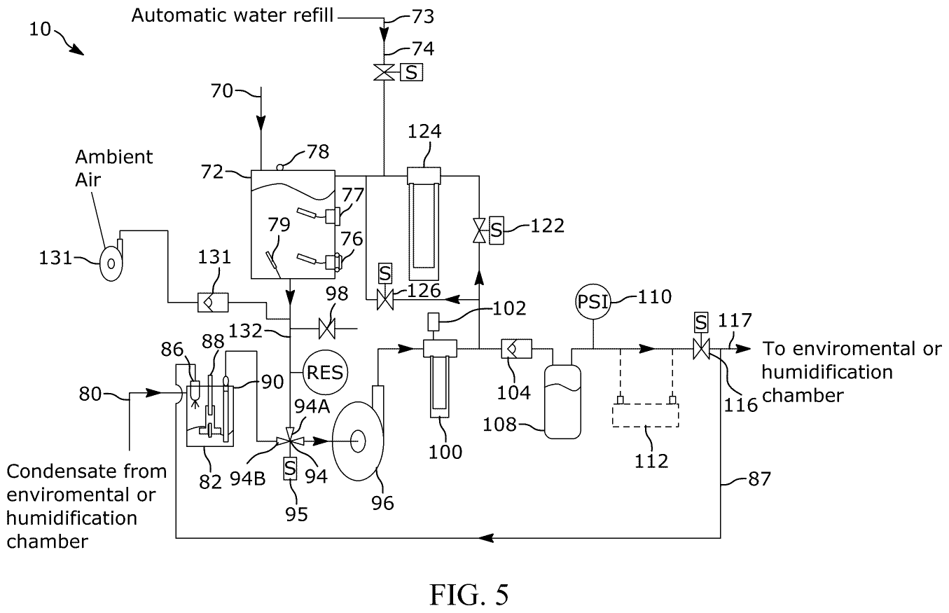

Certain of the water containment and water supply surfaces (e.g., containment tanks and pipes as illustrated in FIG. 5, also referred to as wetted surfaces) of the inventive system are coated with antimicrobial SiO2 (silicone dioxide) during the manufacturing process. The SiO2 prevents bacteria and spores from attaching to and growing on the surfaces. In lieu of SiO2 coating or in addition to the SiO2 coating, a silver (or copper or other antimicrobial material) material is disposed within the system. Bacteria in the water is killed as the water comes into contact with the silver or copper material.

The system comprises a pump that circulates water through internal plumbing loops (wetted surfaces) to prevent water stagnation. In one embodiment a material of the plumbing loop components is stainless steel.

Another embodiment of the invention includes a wetted pipe loop connecting the system to an environmental or humidity chamber. This embodiment includes more wetted components, specifically the water delivery external tubing from the system to the environmental chamber and the return tubing from the chamber back to the system. In addition, the system 10 offers a number of useful features as described below.
1. By operation of the system pump, pressurizes water for output from the system (also referred to as output water or conditioned water) to a value between about 100 psi and 3 psi if the input water is less than 3 psi. A pressurized expansion tank maintains the water pressure within the wetted components. The system can also depressurize the output water if the input water pressure is greater than 100 psi. In one embodiment a preferred output pressure is about 25 psi.
2. Unlike certain prior art systems, the system of the invention does not mix water of two different water quality values to achieve a desired quality of output water. Instead the present invention employs an ionizing or deionizing process to achieve a desired water quality.
3. Input/make-up water may be supplied manually or automatically as indicated in FIG. 2.
4. The system can supply output water to one or more environmental chambers, e.g., humidity-controlled chambers.
5. The system can receive input or reclaimed water from one or more sources, as indicated in FIGS. 2 and 5.

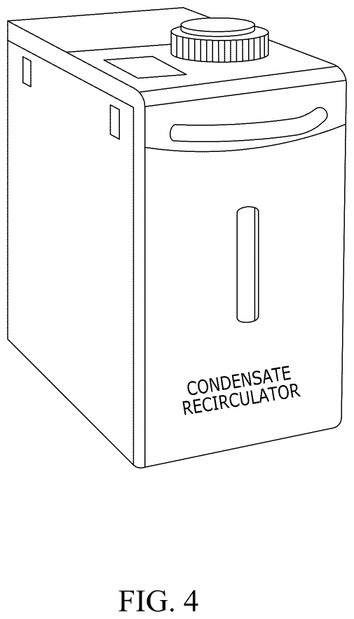

FIG. 4 illustrates a commercial embodiment of the present invention.

A FIG. 5 piping diagram illustrates a commercial embodiment of the system of the present invention, absent output pipes for connection to an environmental chamber.

Principle components of the system 10 are described below.

A water intake line 70 represents the manual fill input 14 of FIG. 2. The incoming water is stored in a holding reservoir 72 (in one embodiment comprising a seven-gallon holding tank).

An automatic water refill input 73, is opened and closed by operation of a solenoid 74.

A low water level switch 76 and a high water level switch 77 in the holding reservoir 72 determine when the water level is low and high. Water is manually or automatically added to the holding tank or water input is terminated responsive to the water level as determined by the low and high water level switches 76 and 77.

Certain embodiments of the system provide only the manual water intake. Manual refill operations do not require the high water level switch 77, as the operator can determine when to terminate the refill operation.

An air bleed valve 78, disposed on an upper surface of the holding reservoir 72, is opened to bleed air from within the reservoir as required.

An antimicrobial element, in one embodiment an antimicrobial stick 79, is disposed within the holding reservoir 72. Stick material may comprise a silver alloy that exhibits these antimicrobial properties. However, antimicrobial material can be placed anywhere within the system 10. Silver beads, disposed within a container, (not sown) can also be placed within the holding reservoir 72.

As further depicted in FIG. 5, an ionization process is activated by pumping ambient air (that includes CO2) via a pump 130 through a controllable solenoid 131 into a water outflow line 132 extending from the holding reservoir 72. The bubbling CO2 ionizes the water in the water outflow line.

The system 10 also receives condensate water from humidity chambers as illustrated in FIG. 2. With reference to FIG. 5, this condensate water is input to the system via a water intake line 80 that supplies water to a lower reservoir 82.

The following components are disposed within the lower reservoir 82.

A small orifice input valve 86 is fed by bleed bypass line 87 that bleeds water from within the system to prevent stagnation and ensure that the water quality is maintained. A controllable orifice of the valve 86 controls the rate at which water returned to the system via the bleed bypass line 87. Since the system 10 is pressurized (i.e., water in the system is maintained in a pressurized state) that pressure determines the rate at which water is removed from the system and supplied back into the system vai the valve 86. In one embodiment and under typical operating and pressure conditions, water is bled from the system and returned to the system at about 1 liter per hour.

A water level switch 88 determines the water level in the lower reservoir 82. The switch 88 terminates condensate water in-flow when the water reaches a predetermined level within the lower reservoir.

A circulating pump 96, operates in conjunction with a water pick-up tube 90 to suction water (but not air) from within the lower reservoir 82.

A 3-way solenoid-operated valve 94 directs water from either the holding reservoir 72 or the lower reservoir 82 (as determined by a configuration of the valve 94 as controlled by a solenoid or motor 95) to the circulating pump 96. According to one embodiment, input 94A of the solenoid is normally closed (from the holding reservoir 72) and input 94B is normally open (from the lower reservoir 82).

Flow directions are indicated by arrowheads on the FIG. 5 flow paths.

The pump 96 supplies water to and through the processing devices as shown in FIG. 5 of the system 10.

A ball valve-controlled drain 98 provides an easy manually-controlled output for draining water from the holding reservoir 72.

A resistivity sensor 99 is disposed in the flow path 132 from the holding reservoir 72. The resistivity sensor communicates with a microprocessor or controller (see FIG. 2) for controlling the various valves and solenoid switches of the system 10 and thereby controlling the water flow paths. Also, other system sensors and measuring devices (e.g., level sensors) communicate with the microprocessor or controller for controlling the valves and switches.

Water pumped from the pump 96 flows through a sediment filter cartridge 100 that purifies the water through mechanical filtration and thereby reduces particulates in the water. The sediment filter may also comprise other filtration techniques and materials, such as a carbon briquettes, that absorb the particulates.

An air bleed valve 102 can be opened to bleed air out from the sediment filter cartridge 100.

A check valve 104 prevents reverse-flow or backflow of water from a pressurized expansion tank 108 (further described below) into system components that precede the tank 108 in the system water flow path.

A pressurized expansion tank 108 stores water and supplies pressurized water to the environmental or humidification chambers, thereby reducing cycling of the pump 96.

A pressure switch or sensor 110 measures water line pressure and controls the pump 96 to maintain an acceptable system pressure for delivering water to the chamber(s). In one embodiment, an acceptable water pressure is between about 10 and 16 PSI.

A UV-C light source 112 disinfects the water by killing bacteria and living organisms. In the illustrated embodiment the UV-C light source is located within the system plumbing. In another embodiment, the UV-C light source is located in the plumbing between the system of the invention and an environmental chamber to which it is connected (for both receiving condensate water from the environmental chamber and supplying conditioned input water to the chamber). In yet another embodiment, the UV-C light source is located within the environmental chamber.

A normally-closed exit solenoid valve 116 controls the supply of water to the chamber(s) and prevents leakage and spillage of the pressurized water out from an output port 117 when the system is “off.” Also, the valve 116 prevents “backfilling” of the water conditioning system from the connected chambers through the outlet port 117, when the system is off.

The normally-closed solenoid valve 116 maintains water pressure within the system when not supplying water to the chamber(s). Otherwise, if an open pipe or tubing intended for connection to an environmental chamber, for example, is connected to an output port 117 and the solenoid 116 is open, system losses pressure as water unexpectedly flows out from the system.

A typical outflow value from the output port 117 is about one gallon every four hours with a maximum outflow of about one gallon per minute. The typical outflow is also a function of the chambers to which the system is connected.

When deionization is indicated, a system microprocessor or controller 17 (see FIG. 2) controls a normally-closed solenoid valve 122 to an open condition to thereby direct water from pump 96/sediment filter 100 through a deionizing resin within a deionizing cartridge 124. The deionized water then flows to the holding reservoir 72.

In the event deionization is not required, the valve 122 is closed and a solenoid valve 126 is opened to direct water from the pump 96/sediment filter 100 to the holding reservoir 72 without passing the water through the deionizing cartridge 124.

What is claimed is:

1. A system for providing conditioned water, comprising:
a holding reservoir for receiving intake water from a water source, the intake water of unknown water quality;
a first pump for pressurizing the system;
a plurality of controllable valves to control water flow paths through the system;
a sensor for measuring the water quality of the water in the holding reservoir or water flowing out from the holding reservoir and for producing a signal representative of a measured water quality;
a device for receiving the signal, for comparing the measured water quality with a desired water quality range or a desired water quality value, and for producing conditioned water by controlling predetermined ones of the controllable valves to deionize the water by subjecting the water to a deionizing component or to ionize the water by subjecting the water to an ionizing component; and
an output valve for controlling outflow of pressurized conditioned water from the system.

2. The system of claim 1, wherein the water source supplies tap water, distilled water, ultra-pure water or water from any source.

3. The system of claim 1, further comprising controlling the output valve to supply the conditioned water to a humidification chamber or to an environmental chamber for use in humidifying the humidification chamber or the environmental chamber.

4. The system of claim 3, further comprising a lower reservoir, and wherein condensate water from the humidification chamber or from the environmental chamber is supplied to the lower reservoir, water in the lower reservoir combined with water from the holding reservoir by opening or closing predetermined valves to create a water flow path that mixes water from the lower reservoir with water from the holding reservoir.

5. The system of claim 4, further comprising a bleed bypass line for feeding back conditioned water from proximate the output valve to a prior system component to prevent water stagnation.

6. The system of claim 5, wherein the prior system component comprises the lower reservoir, the system further comprising a water level switch for determining a water level in the lower reservoir.

7. The system of claim 1, further comprising an antimicrobial silicone dioxide coating applied to wetted surfaces of certain system components.

8. The system of claim 1, wherein the water quality comprises water resistivity between 50 kohm-cm and 1 Mohm-cm.

9. The system of claim 1, wherein the intake water is supplied to the holding reservoir automatically or manually from the water source.

10. The system of claim 1, wherein the device comprises a microprocessor or a microcontroller.

11. The system of claim 1, further comprising one or more of a filter cartridge, a pressurized expansion tank and an ultra-violet purifier, wherein water flows through the one or each of the filter cartridge, the pressurized expansion tank and the ultra-violet purifier, the ultra-violet purifier for disinfecting the water.

12. The system of claim 11, wherein the filter cartridge comprises a sediment filter for absorbing particulates and thereby reducing particulates in the water.

13. The system of claim 12, a material of the filter cartridge comprises carbon briquettes.

14. The system of claim 1, the holding reservoir comprising upper and lower water level detectors each for supplying a water level indication for use during a manual or an automatic supply of intake water to the holding reservoir.

15. The system of claim 1, wherein the ionizing component comprises ambient air containing CO2, and the deionizing component comprises a deionizing cartridge or an ion exchange resin.

16. The system of claim 15, wherein the ambient air is input to water in the holding reservoir or to water in a flow path from the holding reservoir by action of a second pump.

17. The system of claim 1, wherein pressurized water flows through the output valve in an open state to a humidification or environmental chamber.

18. The system of claim 1, wherein the water is continually conditioned by opening or closing one or more of the plurality of the controllable valves to subject the water to the deionizing component or to the ionizing component as determined by the sensor and the device.

19. The system of claim 1, further comprising one or more check valves disposed at system locations to prevent water or air backflow.

20. A system for providing conditioned water, comprising:
a holding reservoir for manually or automatically receiving intake water from a water source, the intake water of unknown resistivity;
upper and lower water level detectors for the holding reservoir each for supplying a water level indication for use during a manual or an automatic supply of intake water to the holding reservoir;
a pump for pressurizing water within the system;
a plurality of controllable valves to control water flow paths through the system;
a sensor for measuring the resistivity of the water in the holding reservoir or water flowing out from the holding reservoir and for producing a signal representative of a measured resistivity;
a microprocessor or microcontroller for receiving the signal, for comparing the measured resistivity with a desired resistivity of between 50 kohm-cm and 1 Mohm-cm, and as needed, for deionizing the water by passing the water through a deionizing cartridge or for ionizing the water by bubbling air containing CO2 within the water;
an output valve for controlling outflow of pressurized and conditioned water to a humidification chamber or to an environmental chamber for use in humidifying the humidification chamber or the environmental chamber;
a lower reservoir for receiving condensate water from the humidification chamber or from the environmental chamber, water in the lower reservoir combined with water from the holding reservoir;
a bleed bypass line for feeding back conditioned water from proximate the output valve to the lower reservoir;
an antimicrobial silicone dioxide coating applied to wetted surfaces of one or more system components;
a filter cartridge for reducing particulate matter in the water;
a pressurized expansion tank; and
an ultra-violet purifier for disinfecting the water.
